(19) United States
(12) Patent Application Publication
(10) Pub. No.: US 2014/0349718 A1
(43) Pub. Date: Nov. 27, 2014

(54) WIRELESS SIGNAL CONTROLLING CIRCUIT

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: GUANG-FENG OU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/093,689

(22) Filed: Dec. 2, 2013

(30) Foreign Application Priority Data
May 24, 2013 (CN) 2013101972383

(51) Int. Cl. H04M 1/02

(52) U.S. Cl. CPC H04M 1/0202
USPC 455/572

(57) ABSTRACT

A wireless signal controlling circuit includes a control module, a wireless signal circuit, and a frequency-to-voltage converter connected to the wireless signal circuit. The control module includes a switch and a power supply. The power supply is connected to the frequency-to-voltage converter. The switch is used to control the power supply to supply a first voltage for the frequency-to-voltage converter. The frequency-to-voltage converter is used to change the first voltage to a second voltage for the wireless signal circuit.

### BACKGROUND

1. Technical Field

The present disclosure relates to wireless signal controlling circuits, and particularly to a wireless signal controlling circuit in an electronic device.

2. Description of Related Art

Wireless network is usually used in different electronic devices, such as mobile phones or notebook. It may harmful for people to use the wireless for a long time, therefore the wireless network needs to be closed when not being used. However, to close the network, one needs to enter into the system of the electronic device, which is inconvenient and laborious. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a wireless signal controlling circuit in accordance with an embodiment.

FIG. 2 is a detailed circuit diagram of the wireless signal controlling circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

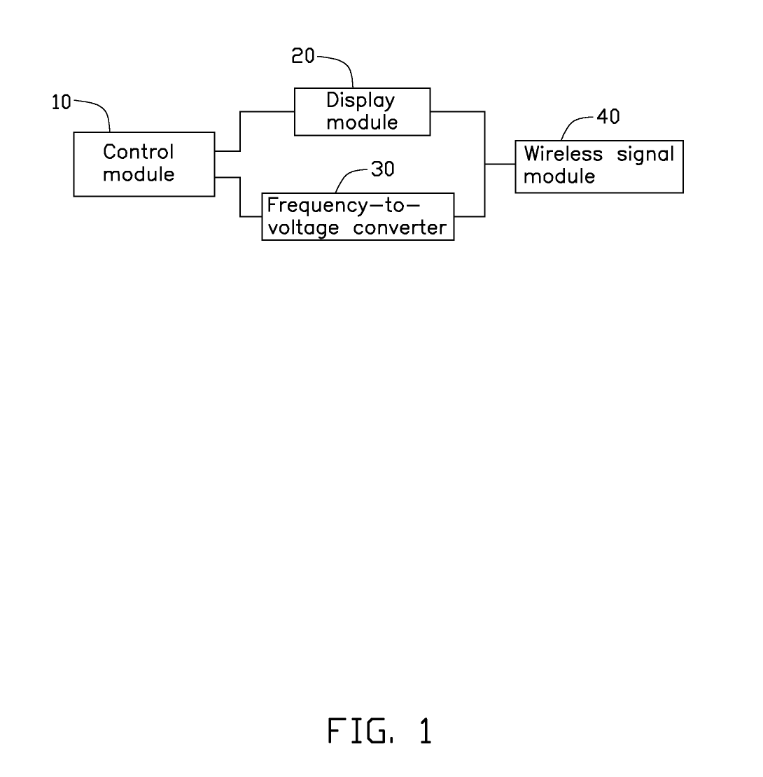

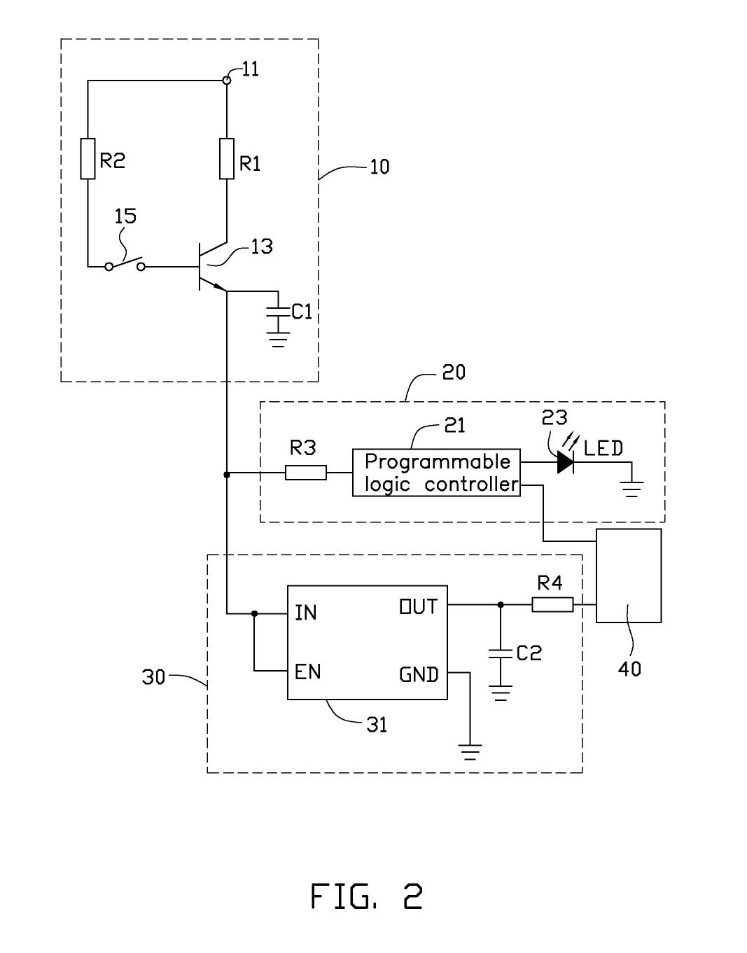

FIGS. 1-2 illustrate a wireless signal controlling circuit in accordance with an embodiment comprises a control module 10, a display module 20, a frequency-to-voltage converter 30, and a wireless signal module 40. The display module 20 is connected to the control module 10 and the wireless signal module 40. The frequency-to-voltage converter 30 is connected to the control module 10 and the wireless signal module 40. The wireless signal module 40 is used to open or close a wireless signal of an electronic device (not shown), such as a mobile phone. The display module 20 is used to display the operational states of the wireless signal module 40.

The control module 10 comprises a power supply 11, a transistor 13, and a switch 15. The power supply 11 is connected to a collector terminal of the transistor 13 via a resistor R1, and further connected to a first end of the switch 15 via a resistor R2. A second end of the switch 15 is connected to the base terminal of the transistor 13. The emitter terminal of the transistor 13 is grounded via a capacitor C1. In one embodiment, the model of the transistor 13 is NPN, and the switch 15 is a normally closed switch.

The display module 20 comprises a programmable logic controller 21 and a display 33. The programmable logic controller 21 is connected to the emitter terminal of the transistor 30, and further connected to the wireless signal module 40. A positive terminal of the display 33 is connected to the programmable logic controller 21. A negative terminal of the display 33 is grounded.

The frequency-to-voltage converter 30 comprises a frequency-DC voltage converter 31. The emitter terminal of the transistor 13 is connected to a pin IN of the frequency-DC voltage converter 31 and a pin EN of the frequency-DC voltage converter 31. A pin OUT of the frequency-DC voltage converter 31 is grounded via a capacitor C2. The pin OUT of the frequency-DC voltage converter 31 is further connected to the wireless signal module 40 via a resistor R4. A pin GND of the frequency-DC voltage converter 31 is grounded. In one embodiment, a model of the frequency-DC voltage converter 31 is TLV70233 and used to supply a voltage for the wireless signal module 40.

In use, when the switch 15 is switched on, the display module 20 and the frequency-to-voltage converter 30 works, and a low level is output by the programmable logic controller 21, and the display 33 is not lit. A 5V voltage supplied by the power supply 11 is change to 3.3V direct current (DC) by the frequency-DC voltage converter 31, to input to the wireless signal module 40. Thus, the wireless signal is opened. When the switch 15 is switched off, the display module 20 and the frequency-to-voltage converter 30 cannot work, and a high level is output by the programmable logic controller 21. The display 33 is lit. The wireless signal module 40 is rendered non-conductive, and the electronic device cannot receive wireless signal. Therefore, it can be determined that the wireless signal module 40 is working according to the display 33. In one embodiment, the switch 15 and the display 23 are secured to an electronic device enclosure.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A wireless signal controlling circuit comprising:
a control module comprising a switch;
a wireless signal circuit; and
a frequency-to-voltage converter connected to the wireless signal circuit; the frequency-to-voltage converter is connected to the power supply;
wherein the switch is configured to control a power supply to supply a first voltage for the frequency-to-voltage converter, and the frequency-to-voltage converter is configured to change the first voltage to a second voltage for the wireless signal circuit.

2. The wireless signal controlling circuit of claim 1, wherein the frequency-to-voltage converter comprises a frequency-DC voltage converter, the control device further comprises a transistor, a collector terminal of the transistor is connected to the power supply via a first resistor, and an emitter terminal of the transistor is connected to an input terminal of the frequency-DC voltage converter.

3. The wireless signal controlling circuit of claim 2, wherein a first end of the switch is connected to the power supply via a second resistor, and a second end of the switch is connected to a base terminal of the transistor.

4. The wireless signal controlling circuit of claim 2, wherein the control module further comprises a first capacitor, the emitter terminal of the transistor is connected to the first capacitor, and the first capacitor is grounded.

5. The wireless signal controlling circuit of claim 2, further comprising a display module, wherein the display module comprises a programmable logic controller connected to the wireless signal module, and the programmable logic controller is connected to the emitter terminal via a second resistor.

6. The wireless signal controlling circuit of claim 5, wherein the display module further comprises a display, a positive terminal of the display is connected to the programmable logic controller, and a negative terminal of the display is grounded.

7. The wireless signal controlling circuit of claim 2, wherein the frequency-to-voltage converter further comprises a second capacitor, an output terminal of the frequency-DC voltage converter is connected to the second capacitor, and the second capacitor is grounded.

8. The wireless signal controlling circuit of claim 7, wherein the output terminal of the frequency-DC voltage converter is connected to the wireless signal module via a fourth resistor.

9. The wireless signal controlling circuit of claim 8, wherein the frequency-DC voltage converter comprises a pin GND, and the pin GND is grounded.

10. A wireless signal controlling circuit comprising:
a control module comprising a switch;
a wireless signal circuit;
a frequency-to-voltage converter connected to the wireless signal circuit; the frequency-to-voltage converter is connected to the power supply; and
a display module connected to the control module;
wherein the switch is configured to control a power supply to supply a first voltage for the frequency-to-voltage converter, the frequency-to-voltage converter is configured to change the first voltage to a second voltage for the wireless signal circuit, and the display module is configured to display whether the second voltage is in the wireless signal circuit.

11. The wireless signal controlling circuit of claim 10, wherein the frequency-to-voltage converter further comprises a frequency-DC voltage converter, the control device further comprises a transistor, a collector terminal of the transistor is connected to the power supply via a first resistor, and an emitter terminal of the transistor is connected to an input terminal of the frequency-DC voltage converter.

12. The wireless signal controlling circuit of claim 11, wherein a first end of the switch is connected to the power supply via a second resistor, and a second end of the switch is connected to a base terminal of the transistor.

13. The wireless signal controlling circuit of claim 11, wherein the control module further comprises a first capacitor, the emitter terminal of the transistor is connected to the first capacitor, and the first capacitor is grounded.

14. The wireless signal controlling circuit of claim 10, wherein the display module comprises a programmable logic controller connected to the wireless signal module, and the programmable logic controller is connected to the emitter terminal via a second resistor.

15. The wireless signal controlling circuit of claim 14, wherein the display module further comprises a display, a positive terminal of the display is connected to the programmable logic controller, and a negative terminal of the display is grounded.

16. The wireless signal controlling circuit of claim 11, wherein the frequency-to-voltage converter further comprises a second capacitor, an output terminal of the frequency-DC voltage converter is connected to the second capacitor, and the second capacitor is grounded.

17. The wireless signal controlling circuit of claim 16, wherein the output terminal of the frequency-DC voltage converter is connected to the wireless signal module via a fourth resistor.

18. The wireless signal controlling circuit of claim 17, wherein the frequency-DC voltage converter comprises a pin GND, and the pin GND is grounded.
